(19) United States
(12) Patent Application Publication
(10) Pub. No.: US 2022/0398604 A1
(43) Pub. Date: Dec. 15, 2022

(54) SYSTEMS AND METHODS FOR DYNAMIC CASH FLOW MODELING

(71) Applicant: JPMORGAN CHASE BANK, N.A., New York, NY (US)

(72) Inventors: Mohamed Ebrahim ABDUL, Voorhees, NJ (US); Anton WIMMER, New York, NY (US); Lucas C. DOWIAK, Brooklyn, NY (US); Zhongnan FANG, New York, NY (US); Abhenandhan SM, Jersey City, NJ (US)

(21) Appl. No.: 17/342,961

(22) Filed: Jun. 9, 2021

(51) Int. Cl. G06Q 30/02; G06N 20/00; G06Q 40/06

(52) U.S. Cl. CPC G06Q 30/0201; G06N 20/00; G06Q 40/06

(57) ABSTRACT

A method for dynamic cash flow modeling may include a cash flow computer program executed by a computer processor: (1) identifying a plurality of cash flow forecasting models, each cash flow forecasting model having a different cash flow forecasting approach; (2) receiving a cash flow forecast request comprising a plurality of cash flow forecast parameters; (3) training each of the plurality of cash flow forecasting models using training data; (4) tuning each of the plurality of cash flow forecasting models to identify optimal hyperparameters for each cash flow forecasting model using a validation data set; (5) selecting one of the plurality of tuned cash flow forecasting models with a lowest error; (6) forecasting, using the selected tuned cash flow forecasting model, a cash flow forecast using the training data set and the validation data set; and (7) outputting the forecast from the selected tuned cash flow forecasting model.

### BACKGROUND OF THE INVENTION

### 1. Field of the Invention

Embodiments relate to systems and methods for dynamic cash flow modeling.

### 2. Description of the Related Art

Cash is the basis on which companies operate. Without a clear line of sight to cash flows, companies can be forced to keep excess cash balances, take on short term funding, and defer investments. Despite its importance the cash flow forecasting process is broken. It is convoluted, complex, time consuming and inaccurate. Software tools, like enterprise resource planning (ERP) and treasury management systems (TMS), do not provide functionality to support forecasting. There is also poor access to clean data sources, as transaction data is often decentralized and of a non-uniform format, and sits in multiple silos, systems, and departments. Further, cash flows are extremely idiosyncratic, with each account having its own unique cash flow behaviors, making it difficult and time consuming to manually analyze and predict flows across many accounts.

### SUMMARY OF THE INVENTION

Systems and methods for dynamic cash flow modeling are disclosed. In one embodiment, a method for dynamic cash flow modeling may include: (1) identifying, by a cash flow computer program executed by a computer processor, a plurality of cash flow forecasting models, each cash flow forecasting model having a different cash flow forecasting approach; (2) receiving, by the cash flow computer program, a cash flow forecast request comprising a plurality of cash flow forecast parameters; (3) training, by the cash flow computer program, each of the plurality of cash flow forecasting models using training data; (4) tuning, by the cash flow computer program, each of the plurality of cash flow forecasting models to identify optimal hyperparameters for each cash flow forecasting model using a validation data set; (5) selecting, by the cash flow computer program, one of the plurality of tuned cash flow forecasting models with a lowest error; (6) forecasting, by the cash flow computer program and using the selected tuned cash flow forecasting model, a cash flow forecast using the training data set and the validation data set; and (7) outputting, by the cash flow computer program, the forecast from the selected tuned cash flow forecasting model.

In one embodiment, the cash flow forecast parameters may include an account, a flow direction, an aggregation period, and a training length.

In one embodiment, the plurality of cash flow forecasting models may be trained for the training length.

In one embodiment, tuning each of the plurality of cash flow forecasting models may result in a plurality of hyperparameters.

In one embodiment, the plurality of cash flow forecasting models may be tuned with a validation data set.

In one embodiment, the cash flow forecasting approach may include time-series models, simple moving average models, regression-based models, and machine-learning models.

In one embodiment, the method may further include weighting, by the cash flow computer program, cash flow forecasts from a plurality of tuned cash flow forecasting models.

In one embodiment, the cash flow forecasting models may include Prophet, moving average, nearest neighbor, seasonal autoregressive integrated moving average (SARIMA), monthly schedule, and/or weekly schedule.

According to another embodiment, an electronic device may include a computer processor and a memory storing a cash flow computer program. The cash flow computer program may be configured to: identify a plurality of cash flow forecasting models, each cash flow forecasting model having a different cash flow forecasting approach; receive a cash flow forecast request comprising a plurality of cash flow forecast parameters; train each of the plurality of cash flow forecasting models using training data; tune each of the plurality of cash flow forecasting models to identify optimal hyperparameters for each cash flow forecasting model using a validation data set; select one of the plurality of tuned cash flow forecasting models with a lowest error; forecast a cash flow forecast using the training data set and the validation data set using the selected tuned cash flow forecasting model; and output the forecast from the selected tuned cash flow forecasting model.

In one embodiment, the cash flow forecast parameters may include an account, a flow direction, an aggregation period, and a training length.

In one embodiment, the plurality of cash flow forecasting models may be trained for the training length.

In one embodiment, tuning each of the plurality of cash flow forecasting models may result in a plurality of hyperparameters.

In one embodiment, the plurality of cash flow forecasting models may be tuned with a validation data set.

In one embodiment, the cash flow forecasting approach may include time-series models, simple moving average models, regression-based models, and machine-learning models.

In one embodiment, the cash flow computer program may be further configured to weight cash flow forecasts from a plurality of tuned cash flow forecasting models.

In one embodiment, the cash flow forecasting models may include Prophet, moving average, nearest neighbor, seasonal autoregressive integrated moving average (SARIMA), monthly schedule, and/or weekly schedule.

According to another embodiment, a system may include an electronic device comprising a computer processor and a memory storing a cash flow computer program, a plurality of data sources, and a user interface. The cash flow computer program may be configured to: identify a plurality of cash flow forecasting models, each cash flow forecasting model having a different cash flow forecasting approach; receive a cash flow forecast request comprising a plurality of cash flow forecast parameters from the user interface, wherein the cash flow forecast parameters comprise an account, a flow direction, an aggregation period, and a training length; train each of the plurality of cash flow forecasting models using training data, wherein the plurality of cash flow forecasting models are trained for the training length; tune each of the plurality of cash flow forecasting models to identify optimal hyperparameters for each cash flow forecasting model using a validation data set; select one of the plurality of tuned cash flow forecasting models with a lowest error; forecast a cash flow forecast using the training data set and the validation data set using the selected tuned cash flow forecasting model; and output the forecast from the selected tuned cash flow forecasting model to the user interface.

In one embodiment, tuning each of the plurality of cash flow forecasting models may result in a plurality of hyperparameters.

In one embodiment, the cash flow forecasting approach may include time-series models, simple moving average models, regression-based models, and machine-learning models.

In one embodiment, the cash flow computer program may be further configured to weight cash flow forecasts from a plurality of tuned cash flow forecasting models.

### BRIEF DESCRIPTION OF THE DRAWINGS

In order to facilitate a fuller understanding of the present invention, reference is now made to the attached drawings. The drawings should not be construed as limiting the present invention but are intended only to illustrate different aspects and embodiments.

FIG. 1 illustrates a system for dynamic cash flow modeling according to one embodiment;

FIG. 2 depicts a method for dynamic cash flow modeling according to one embodiment; and

FIG. 3 depicts a visualization of a cash flow modeling output according to one embodiment.

### DETAILED DESCRIPTION OF PREFERRED EMBODIMENTS

Embodiments are directed to systems and methods for dynamic cash flow modeling.

Embodiments may use past transaction data to support cash flow analytics and short-to-mid-term forecasting, created by machine-learning algorithms. Using cash flow intelligence, users may have the ability to research historical cash flows, identify patterns and trends, and investigate drivers of past forecast errors to make better predictions about the future. At the core of CFI are machine learning models that assist treasurers with their tasks and help build more precise forecasts faster.

One of the defining characteristics of cash-flows is their sheer variability. For example, account structures may differ widely across clients, forecasting challenges differ across each account's purpose (e.g., accounts receivable/accounts payable, payroll, funding, Nostro/Vostro, tax, receivables on behalf of/payments on behalf of, etc.), the possibility of spikes (e.g., orders of magnitude large than the historical average, are unusual, but expected), the average time, across accounts, between observing two consecutive transactions has a vast range, and the wide variety of the number of transactions that an account may see (e.g., some accounts see thousands of transactions per day, while others average three or four transactions per quarter).

Because of this, embodiments use an ensemble approach to forecasting. For example, estimates are collected from a variety of forecasting models to output and form a single forecast value. Examples of forecasting models include Prophet (e.g., a curve-fitting model that follows a “trend+seasonality+holiday” approach), moving average (e.g., a moving average of recent activity), nearest neighbor (e.g., what happened the last time similar history was observed in the recent past), seasonal autoregressive integrated moving average (SARIMA) (e.g., uses lags and moving averages to model cash flow time series), monthly schedule (e.g., based on historical flows on the same day of the month), and weekly schedule (e.g., based on historical flows on the same day of the week).

Each forecasting model may have a different forecasting approach. For example, Arima and Prophet may be considered to be “classical” time series models that specifically model the time evolution of the cash flow series. Simple moving average and seasonal moving average models forecast by averaging the most recent history. The Monthly and Weekly schedule models are regression based models that use date features as the explanatory variables. And the nearest neighbor model is a machine learning model.

In embodiments, moving average models may be an anchor for the ensemble, and provide ceiling on any forecast error. For example, a simple moving average may calculate a forecast for tomorrow (Fₜ) by the previous L days/weeks, Aₜ₋ₛ. For a forecast horizon greater than one, the averages are calculated recursively. For instance, to forecast two days into the future:

Fₜ=mean([Aₜ₋₁ Aₜ₋₂ . . . A_{t-L}])

Fₜ₊₁=mean([Fₜ Aₜ₋₁ . . . A_{t-L+1}])

where:
L is the number of previous days to average; and
Grid search for number of lags to average: 1-15 (The max lag value of 15 implies averaging the last three weeks of cash-flows. Averaging larger values than that would not materially change the forecasted values).

A seasonal moving average is similar to the simple moving average, but instead of averaging the previous L days for tomorrow's forecast, the model averages the same previous L days-of-the-week. Again, for a forecast horizon greater than one, this average is calculated recursively. For instance, to forecast two Mondays into the future:

Fₜ=mean([Aₜ₋₇ Aₜ₋₁₄ . . . A_{t-7*L}])

Fₜ₊₇=mean([Fₜ Aₜ₋₇ . . . A_{t-7*(L+1)}])

where
L: the number of the same previous days of the week to average; and
Grid search for number of lags (of the same day of the week) to average: 1-5 (The max lag value of 5 includes the same week of the previous month, which would determine and if present capture any monthly seasonal effects in the data)

Embodiments may use time-series models, such as SARIMA and Prophet. These models are best suited to model cash flows that have strong recurring patterns at predictable time intervals. SARIMA is a well-known time series model that uses past observed values and past errors to produce forecasts into the future. The SARIMA model is specified as ARIMA (p, d, q) (P, D, Q), where p is the number of autoregressive terms, q is the number moving average terms, P is the number of seasonal autoregressive terms, Q is the number season moving average terms, and s is the seasonality (e.g., for daily, s=5; for weekly, s=4).

Prophet+ is an adaptation of Prophet, a generalized additive model (GAM) estimated in a Bayesian framework. It has three main additive components: Fₜ=g(t)+s(t)+h(t)+εₜ, where g(t) is the piecewise-linear growth trend. Prophet tries to model two types of growth models i) a nonlinear saturating growth model or ii) a linear growth model.

Linear trend is useful for forecasting problems that do not exhibit saturating growth. It models a piecewise constant rate for growth:

g(t)=k t+m

Because the growth may not be fixed but may change over time, the model allows it to change by identifying change-points in the trend over time. Prophet, by default, assumes a large number of potential change points (e.g., one per month) and they can also be provided by the developer. The model allows the linear trend to change between each change point but a Bayesian prior on the change point locations is used to ensure the that shifts in the trend are no more frequent than necessary.

Prophet+ may include s(t), a Fourier-based seasonal component. Time series often have multi-period seasonality (e.g. a weekly pattern and a quarterly pattern). Prophet uses Fourier series to provide a flexible model of periodic effects. The seasonal effects are approximated with a standard Fourier series where the coefficients (aₙ and bₙ) may be learned using training data.

$$s ( t ) = {\sum }_{n = 1}^{N} ( {a}_{n} cos \frac{2 π n t}{P} + {b}_{n} sin \frac{2 π n t}{P} )$$

where: P=365.25 for annual data and P=7 for weekly data.
The Prophet Paper recommends N=10 and N=3 to work well for yearly and weekly seasonality respectively;
h(t): Intercept terms for holidays to control for unusual spikes in account activity. Holidays and events provide predictable shocks to many time series and the model allows the use of a custom list of past and future dates. An indicator function is added representing whether time t is during holiday i, and a parameter kᵢ is assigned to each holiday which is the corresponding change in the forecast.

Pattern-based models are also used. Unlike time-series models, pattern-based models do not have parameters that are estimated on a set of observed values using an objective function. Instead, these models group together “similar” sequences of cash flows and draw inference for forecasts from those groups.

The nearest neighbor model scans the historical flows for sequence of days “closest” to recent history.

The basic outline of the algorithm is simple. To produce a forecast Fₜ, set Aₜ₋₁=[Aₜ₋₁ Aₜ₋₂ . . . A_{t-L}] and find the top K (closest neighbors) s* that minimizes the Euclidian distance ∥Aₜ₋₁−Aₜ₋ₛ∥₂. Then, set Fₜ=(Σ_{s*}A_{t-s*+1})/|K| wherein: Model parameters:
K: the number of closest neighbors to average;
Grid search for number of neighbors: 1-10;
L: the history length use when defining the shape of vector A₍ₜ₋₁₎ (grid search for number of lags: 1-15 (matched with the simple moving average model).

Calendar models may be used. Rather than modeling cash-flows explicitly as a sequence of values over time, the calendar model removes the time dimension entirely and replaces it with a simple regression on set of features that are designed to express all of a client's cash-flows in a “typical” month. For example, a monthly schedule model creates features based on the days within a month. Each of the following is treated as a categorical variable, such as the numeric day of the month (e.g., 1-31), an identifier for the first day of the month (e.g., 1-0 value), an identifier for the last day of the month (e.g., 1-0 value), a day-after-holiday flag, a day-before-holiday flag, a cyber Monday flag, a month-of-year, etc. The month-of-year variable interacts with the other variables to produce a feature set that represents a standard “month” of the year for each client's cash flows. These features may be combined with a LASSO regression, which allows the model to adapt to the unique data-generating-process in each account flow by forcing coefficients on the “irrelevant” features toward zero.

A lasso regression is used to find fitted values and use as forecasts.

Model parameters:
λ: the strength of the penalty term on the size of the regression coefficients
Set the largest grid point equal to the max of the series:
λ_max=max(value)
Set the smallest grid point to 1/1000 of the max
λ_min=end*0.001
Make 10 equally spaced grid points on the log scale:
log 10(λ_max) to log 10(λ_min)

A weekly schedule model creates features based on the weeks within a month. Week of the month (WOM) is treated as a categorical variable. Time is represented as an integer 1:N.

A simple regression y=constant+B1*time+B2*WOM for each individual WOM (1-5) may be used, and lasso regression may be used to reduce the likelihood of overfitting, rather than feature selection.

Model parameters:
λ: the strength of the penalty term on the size of the regression coefficients
Set the largest grid point equal to the max of the series:
λ_max=max(value)
Set the smallest grid point to 1/1000 of the max
λ_min=end*0.001
Make 10 equally spaced grid points on the log scale:
log 10(λ_max) to log 10(λ_min)

The “ensemble” model is a framework for running the models listed above in and returning the individual model that performs the best. For a given sequence of cash flow values, all the models may run in a parallel fashion. Each of the models will produce its own forecast and its own validation data set.

In addition, combinations of outputs of different models may be used. For example, the model may produce a set of forecasts for every two-model combination by averaging the forecast generated on validation data set by the selected models. The two-model combinations may also be considered during model evaluation.

Using the validation data sets, the model(s) that have the best forecast performance (e.g., lowest error rate) is selected, and the output of those model(s) may be used as the ensemble's forecast.

Additional and/or different models may be used as is necessary and/or desired.

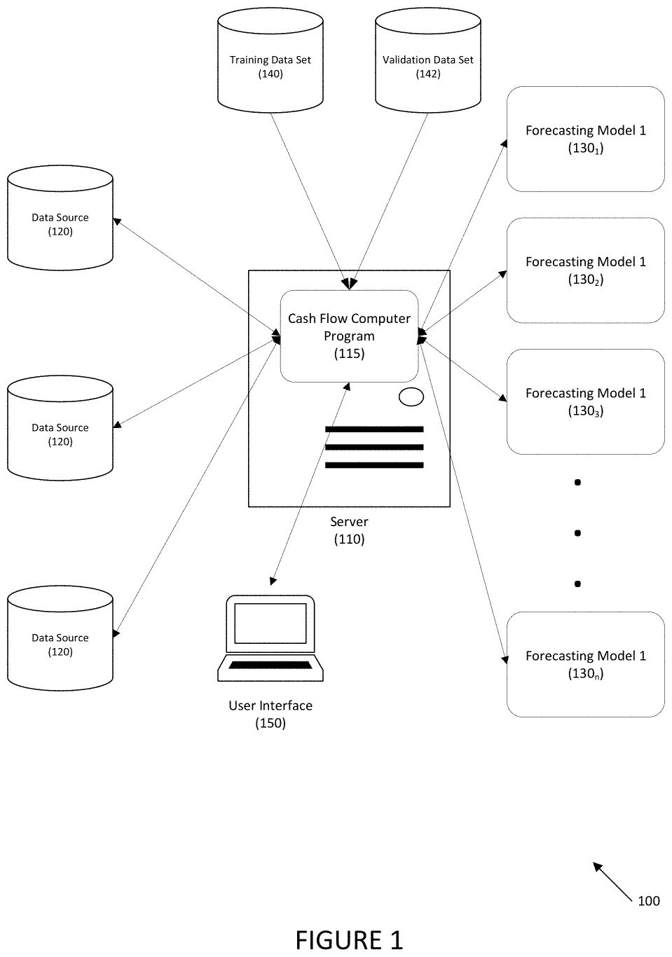

Referring to FIG. 1, a system for dynamic cash flow modeling is provided according to an embodiment. System 100 may include server 110 that may execute cash flow computer program 115. Server 110 may be a physical server, a cloud-based server, combinations thereof, etc. Cash flow computer program 115 may access a plurality of forecasting models 130₁, 130₂, 130₃, . . . 130ₙ and may take an ensemble approach to forecasting cash flow for a client. Example forecasting models include Prophet+, moving average, nearest neighbor, ARIMA, monthly schedule, and weekly schedule (e.g., based on historical flows on the same day of the week).

Cash flow computer program 115 may use machine learning to train each model using historical data and may select the model that provides the most accurate cash flow forecast.

System 100 may further include one or more databases 120. Databases 120 may provide historical data for a client, such as transaction history, balance history, etc.

System 100 may include one or more database comprising training data set 140 of historical data and validation data set 142 of historical data. In one embodiment, data sets 140 and 142 may be part of the same data set. Training data set 140 and validation data set 142 may include historical data and cash flow data for a period of time. In one embodiment, historical values may be broken into training data set 140 and validation data set 142.

For example, the sizes of the validation data set, the training set, and the forecast set may be selected using the following tables:

TABLE I
Daily Data

| Series Length | Validation | Training Size | Forecast |
|---|---|---|---|
| 80 | Not enough data | | |
| 100 | 30 | 70 | 10 |
| 120 | 35 | 85 | 10 |
| 140 | 40 | 100 | 15 |
| 160 | 45 | 115 | 15 |
| 180 | 50 | 130 | 20 |
| 200 | 55 | 145 | 20 |
| 220 | 60 | 160 | 20 |
| 240 | 65 | 175 | 20 |
| 260 | 70 | 190 | 20 |
| 280 | 75 | 205 | 20 |
| 300 | 80 | 220 | 20 |
| 320 | 80 | 240 | 20 |
| 340 | 80 | 260 | 20 |
| 360 | 80 | 280 | 20 |
| 380 | 80 | 300 | 20 |
| 400 | 80 | 320 | 20 |
| 420 | 80 | 340 | 20 |
| 440 | 80 | 360 | 20 |
| 460 | 80 | 380 | 20 |
| 480 | 80 | 400 | 20 |
| 500 | 80 | 420 | 20 |
| 520 | 80 | 440 | 20 |

TABLE II
Weekly Data

| Series Length | Validation | Train Size | Forecast |
|---|---|---|---|
| 16 | Not enough data | | |
| 32 | Not enough data | | |
| 48 | 20 | 28 | 10 |
| 64 | 25 | 39 | 15 |
| 80 | 30 | 50 | 20 |
| 96 | 40 | 56 | 24 |
| 112 | 40 | 72 | 24 |
| 128 | 40 | 88 | 24 |
| 144 | 40 | 104 | 24 |
| 160 | 40 | 120 | 24 |

In one embodiment, cash flow computer program 115 may pad the data in data sets 140 and 142 to reflect the absence of transactions. For example, embodiments may take an accounts daily aggregate flows, identify the earliest observable date with a transaction and the most recent date for which there is data available, and then fill in any missing business days between the two dates with zeros to represent the absence of any transaction values.

System 100 may be provided with user interface 150 for interfacing with cash flow computer program 115. User interface 150 may be a computer, a downstream system, etc. In one embodiment, a user may provide parameters and request cash flow forecasting from cash flow computer program 115 using user interface 150.

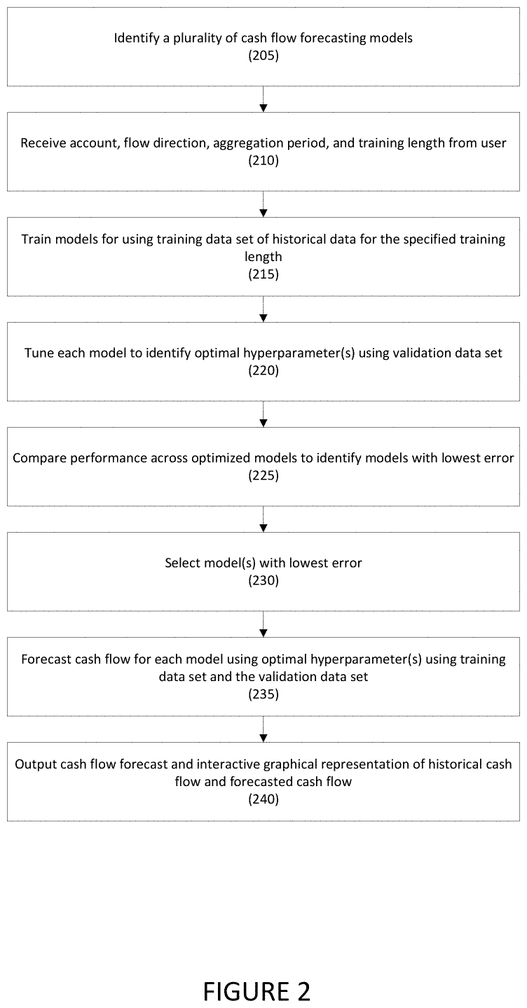

Referring to FIG. 2, a method for dynamic cash flow modeling is provided according to an embodiment.

In step 205, a cash forecasting computer program executed by a computer processor may identify a plurality of forecasting models. In one embodiment, moving average models, time series models, pattern-based models, and/or calendar-based models may be used. Examples of suitable forecasting models include Prophet+, moving average, nearest neighbor, SARIMA, monthly schedule, and weekly schedule. Other forecasting models may be used as is necessary and/or desired.

In step 210, the cash forecasting computer program may receive parameters from a user. The parameters may include, for example, an account, a flow direction, an aggregation period, and a training length. The account may identify the account for which the cash flow will be forecast. A flow direction may indicate whether the cash flow is to the account or from the account. The aggregation may indicate whether daily flow totals or weekly flow totals are being forecasted. The training length may indicate the amount (e.g., length) of training data that may be used to train the model(s). Any suitable training length may be used, such as 1 year, 2 years, etc., and each model may have different training times.

In step 215, the computer program may train the plurality of models for the specified training length using a training data set, such as historical data.

In step 220, each of the trained models may be tuned to identify one or more hyper-parameters. For example, each model has hyper-parameters that may be tuned to each specific time series. The hyper-parameters that, when tested on the validation data set, provide the lowest forecast error on the validation data set are selected.

In one embodiment, the hyper-parameter h for each model M may be selected using the methodology:

$${h}^{⋆} = arg {min}_{h} SMAPE ( M , h )$$

$$where$$

$$SMAPE = \frac{100 \%}{n} {\sum }_{i = 1}^{n} \frac{\vert {F}_{t} - {A}_{t} \vert}{( \vert {A}_{t} \vert + \vert {F}_{t} \vert ) / 2}$$

$$where {A}_{t} is the actual value and {F}_{t} is the forecast value$$

Once the optimal hyper-parameters have been found, each of the plurality of models may be tuned using the combined training data set and validation data set with the hyper-parameters. For example, the models may be re-optimized using the full historical data using the hyper-parameters that were identified in step 220.

In step 225, the performance of each model may be compared to identify the model(s) that have the lowest error rate. In one embodiment, validation forecast errors may be produced in a rolling manner. For example, the following process may be used: (1) set the forecast length N; (2) for date d in the validation data set: (a) use all dates s<d as the training data set; (b) record the N-day-ahead forecast; and (3) step ahead one day (d=d+1) and repeat steps a and b. The generated forecasts are the compared to the actuals cash flow in the validation data set to gauge model performance.

In step 230, the model(s) with the lowest error may be selected, and in step 235, the cash flow for each model may be forecast using the validation data set and the training data set.

In one embodiment, the forecast may be recorded relative to another model, such as the moving average model.

In one embodiment, if multiple models are used, the outputs may be weighted, averaged, etc. For example, if one model provides the best results at certain times, but another provides the best results at different times, the model that provides the most accurate results may be selected. Embodiments may use machine learning to identify signals or features to learn when to apply different models, different weighting, etc. The forecasts may then be integrated using the machine-learning model.

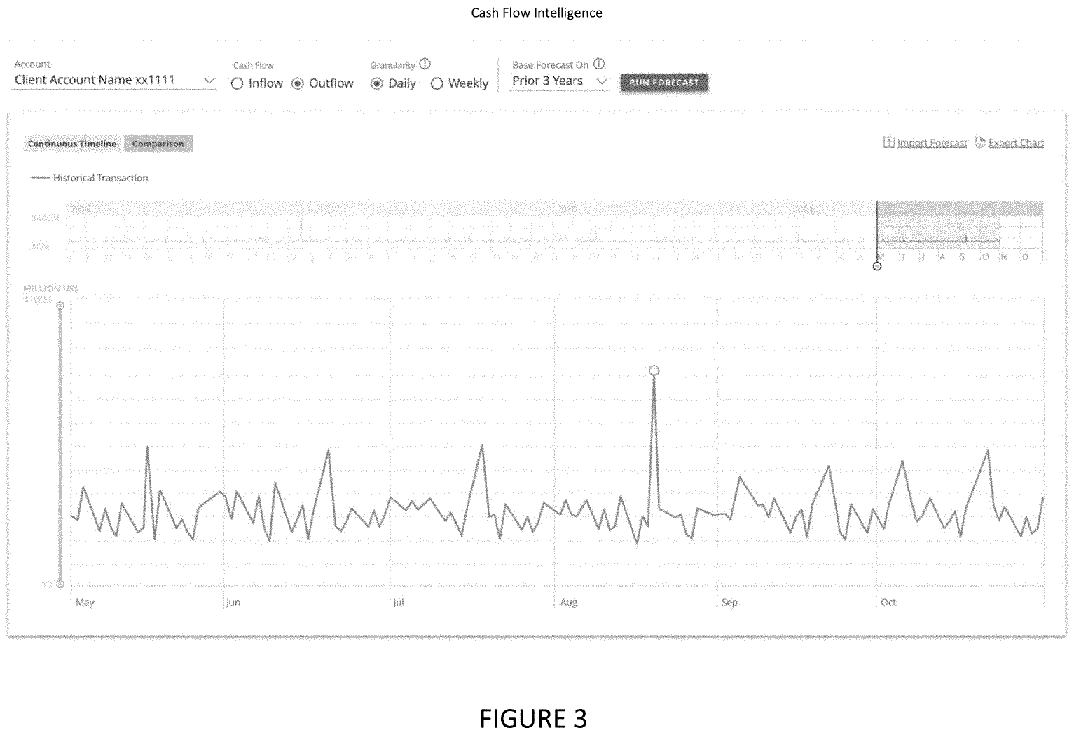

In step 240, the cash flow forecast may be output. For example, the cash flow forecast may be output as a graphical representation with the historical cash flow and the forecasted cash flow. FIG. 3 depicts an exemplary visualization of a cash flow modeling output according to one embodiment.

Although several embodiments have been disclosed, it should be recognized that these embodiments are not exclusive to each other, and certain elements or features from one embodiment may be used with another embodiment.

It will be appreciated by persons skilled in the art that the present invention is not limited by what has been particularly shown and described hereinabove. Rather, the scope of the present invention includes both combinations and sub-combinations of features described hereinabove and variations and modifications thereof which are not in the prior art. It should further be recognized that these embodiments are not exclusive to each other.

It will be readily understood by those persons skilled in the art that the embodiments disclosed here are susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

Accordingly, while the present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method for dynamic cash flow modeling, comprising:
identifying, by a cash flow computer program executed by a computer processor, a plurality of cash flow forecasting models, each cash flow forecasting model having a different cash flow forecasting approach;
receiving, by the cash flow computer program, a cash flow forecast request comprising a plurality of cash flow forecast parameters;
training, by the cash flow computer program, each of the plurality of cash flow forecasting models using training data;
tuning, by the cash flow computer program, each of the plurality of cash flow forecasting models to identify optimal hyperparameters for each cash flow forecasting model using a validation data set;
selecting, by the cash flow computer program, one of the plurality of tuned cash flow forecasting models with a lowest error;
forecasting, by the cash flow computer program and using the selected tuned cash flow forecasting model, a cash flow forecast using the training data set and the validation data set; and
outputting, by the cash flow computer program, the forecast from the selected tuned cash flow forecasting model.

2. The method of claim 1, wherein the cash flow forecast parameters comprise an account, a flow direction, an aggregation period, and a training length.

3. The method of claim 2, wherein the plurality of cash flow forecasting models are trained for the training length.

4. The method of claim 1, wherein tuning each of the plurality of cash flow forecasting models results in a plurality of hyperparameters.

5. The method of claim 1, wherein the plurality of cash flow forecasting models are tuned with a validation data set.

6. The method of claim 1, wherein the cash flow forecasting approach comprises time-series models, simple moving average models, regression-based models, and machine-learning models.

7. The method of claim 1, further comprising:
weighting, by the cash flow computer program, cash flow forecasts from a plurality of tuned cash flow forecasting models.

8. The method of claim 1, wherein the cash flow forecasting models comprise Prophet, moving average, nearest neighbor, seasonal autoregressive integrated moving average (SARIMA), monthly schedule, and/or weekly schedule.

9. An electronic device, comprising:
a computer processor; and
a memory storing a cash flow computer program;
wherein the cash flow computer program is configured to:
identify a plurality of cash flow forecasting models, each cash flow forecasting model having a different cash flow forecasting approach;
receive a cash flow forecast request comprising a plurality of cash flow forecast parameters;
train each of the plurality of cash flow forecasting models using training data;
tune each of the plurality of cash flow forecasting models to identify optimal hyperparameters for each cash flow forecasting model using a validation data set;
select one of the plurality of tuned cash flow forecasting models with a lowest error;
forecast a cash flow forecast using the training data set and the validation data set using the selected tuned cash flow forecasting model; and
output the forecast from the selected tuned cash flow forecasting model.

10. The electronic device of claim 9, wherein the cash flow forecast parameters comprise an account, a flow direction, an aggregation period, and a training length.

11. The electronic device of claim 10, wherein the plurality of cash flow forecasting models are trained for the training length.

12. The electronic device of claim 9, wherein tuning each of the plurality of cash flow forecasting models results in a plurality of hyperparameters.

13. The electronic device of claim 9, wherein the plurality of cash flow forecasting models are tuned with a validation data set.

14. The electronic device of claim 9, wherein the cash flow forecasting approach comprises time-series models, simple moving average models, regression-based models, and machine-learning models.

15. The electronic device of claim 8, wherein the cash flow computer program is further configured to weight cash flow forecasts from a plurality of tuned cash flow forecasting models.

16. The electronic device of claim 9, wherein the cash flow forecasting models comprise Prophet, moving average, nearest neighbor, seasonal autoregressive integrated moving average (SARIMA), monthly schedule, and/or weekly schedule.

17. A system, comprising:
an electronic device comprising a computer processor and a memory storing a cash flow computer program;
a plurality of data sources; and
a user interface;
wherein:
the cash flow computer program is configured to identify a plurality of cash flow forecasting models, each cash flow forecasting model having a different cash flow forecasting approach;
the cash flow computer program is configured to receive a cash flow forecast request comprising a plurality of cash flow forecast parameters from the user interface, wherein the cash flow forecast parameters comprise an account, a flow direction, an aggregation period, and a training length;
the cash flow computer program is configured to train each of the plurality of cash flow forecasting models using training data, wherein the plurality of cash flow forecasting models are trained for the training length;
the cash flow computer program is configured to tune each of the plurality of cash flow forecasting models to identify optimal hyperparameters for each cash flow forecasting model using a validation data set;
the cash flow computer program is configured to select one of the plurality of tuned cash flow forecasting models with a lowest error;
the cash flow computer program is configured to forecast a cash flow forecast using the training data set and the validation data set using the selected tuned cash flow forecasting model; and
the cash flow computer program is configured to output the forecast from the selected tuned cash flow forecasting model to the user interface.

18. The system of claim 17, wherein tuning each of the plurality of cash flow forecasting models results in a plurality of hyperparameters.

19. The system of claim 17, wherein the cash flow forecasting approach comprises time-series models, simple moving average models, regression-based models, and machine-learning models.

20. The system of claim 17, wherein the cash flow computer program is further configured to weight cash flow forecasts from a plurality of tuned cash flow forecasting models.
